(19) United States
(12) Patent Application Publication
(10) Pub. No.: US 2015/0378807 A1
(43) Pub. Date: Dec. 31, 2015

(54) PREDICTING PROCESS FAILURES USING ANALYTICS

(71) Applicant: International Business Machines Corporation, Armonk, NY (US)

(72) Inventors: Martin H. Ball, Renfrewshire (GB); Sourav K. Behera, Kolkata (IN); Satyaki Bhattacharya, Kolkata (IN); Elaine M. Branagh, Austin, TX (US); Pitipong J. Lin, Brookline, MA (US)

(21) Appl. No.: 14/318,864

(22) Filed: Jun. 30, 2014

(51) Int. Cl. G06F 11/07

(52) U.S. Cl. CPC G06F 11/0751; G06F 11/0793

(57) ABSTRACT

A set of data records chronicles attributes of a component in a process over a time period. The time period includes a failure event associated with the component. A status is assigned to the component on each record date in the time period based on the temporal proximity of the record date to the failure event. A computer-based predictive analytics model is developed for predicting the assigned statuses based on the attributes of the failing component. The computer-based predictive analytics model is then applied to a second set of data records that is chronicling the component attributes in the current time period, and predicts a future failure event based on those attributes. An action is then performed based on the predicted future failure event.

### BACKGROUND

The present disclosure relates to process management, and more specifically relates to predicting process failures by developing an analytics model from historical process data and applying the analytics model to current process data.

Integral to process management is the management of individual components within the process. For example, a manufacturing process may involve the assembly of a product from multiple parts. A manufacturer will typically try to keep a ready supply of each part to meet its short-term demand without the need to store large numbers of parts. For another example, a customer service process may employ a number of phone operators to take incoming customer service calls. A service provider will typically try to keep enough operators available to avoid lengthy customer wait times while avoiding idle time for any of the phone operators.

### SUMMARY

Disclosed herein are embodiments of a method, a computer program product, and a computer system for predicting failures in a process. A computer system identifies a set of data records generated over a time period. Each data record has a record date within the time period. The set of data records chronicles attributes of a component in the process during the time period. The component is associated with a failure event during the time period. A status is assigned to the component on each record date in the set of data records. The status is based on a temporal proximity of the record date to the failure event.

A computer system develops a computer-based predictive analytics model. The model is based at least in part on a model equation for predicting the status on the record dates in the set of data records. Each predicted status is based at least in part on the attributes chronicled on the associated record date.

A computer system identifies a second set of data records generated over a second time period. The second set of data records chronicles the attributes of the component during the second time period. The computer-based predictive analytics model is applied to the second set of data records and predicts a future failure event. An action is performed based on the prediction.

The above summary is not intended to describe each illustrated embodiment or every implementation of the present disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 is a flow diagram of an example method for predicting process failures using a computer-based predictive analytics model.

FIG. 2 is a flow diagram of an example method for creating a working set of historical process data records for use in developing a computer-based predictive analytics model for a process component.

FIG. 3 is a flow diagram of an example method for developing a computer-based predictive analytics model for a process component.

FIG. 4 is a flow diagram of an example method for applying a computer-based predictive analytics model for predicting process failures to current process data records.

FIG. 5 is a block diagram of an example system for predicting process failures using a computer-based predictive analytics model.

FIG. 6 is a high-level block diagram of an example system for implementing one or more embodiments of the invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

Aspects of the present disclosure relate to process management, and more particular aspects relate to predicting process failures by developing an analytics model from historical process data and applying the analytics model to current process data. While the present disclosure is not necessarily limited to such applications, various aspects of the disclosure may be appreciated through a discussion of various examples using this context.

When an individual component of a process experiences a failure event, emergency post-failure corrective action must usually be taken. Such corrective action is typically costly. For example, supply continuity is essential for an efficient, low-cost supply chain, and parts shortages create expense and impact customer satisfaction. To meet production quotas, a parts shortage may result in the need to purchase additional parts at non-optimal pricing, or may result in the need to modify a production line to use substitute parts. Customer demand planning continues to challenge process managers who are trying to provide a smooth supply line.

Advanced analytics provides an opportunity to identify process components which are likely to become critical in the near future, and therefore allows for proactive mitigation. Such proactive mitigation may provide a more effective supply assurance process at the component level, and may provide an overall improvement in process yield. Such proactive mitigation may also improve inventory management and reduce variable costs, such as the cost of expediting parts to address a parts shortage or the overtime payroll costs associated with a personnel shortage.

When process data is available that chronicles various attributes of various components of a process over time, applying advanced analytics techniques to historical process data can reveal patterns that, when present in current process data, may indicate that a failure event is on the horizon. Because the historical data is associated with known outcomes, models can be developed that predict the known outcomes. Applying these models to current data may then allow prediction of a future failure event, and corrective action may be taken to avoid or mitigate the effects of the future failure event.

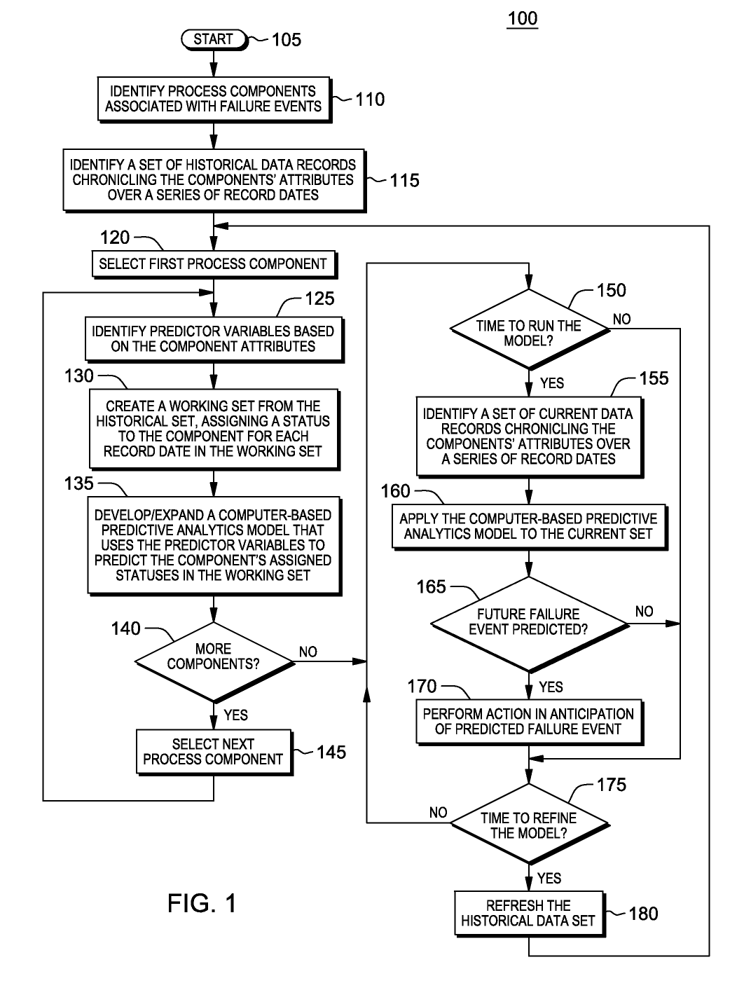

FIG. 1 is a flow diagram of an example method 100 for predicting process failures using a computer-based predictive analytics model. From start 105, one or more specific process components are identified at 110 that have experienced failure events or have been otherwise associated with failure events. For example, a manufacturing process involving multiple parts may have experienced at least one past shortage of Part A and at least one past shortage of Part B.

A set of historical process data records that chronicles attributes of the components over time is identified at 115. For example, a manufacturing process may create an hourly record, a daily record, a weekly record, or a differently scaled time-based record of several attributes associated with Part A. Each record is associated with a record date, and each record provides a snapshot of the value of Part A's attributes on that record date. Such Part A attributes might be, for example, an identifier for Part A, the quantity of Part A currently available in local stock, whether Part A is available in regional stock (for example in a hub that services multiple manufacturing processes), the quantity of Part A currently available in regional stock, the quantity of Part A expected to arrive within the next week, the quantity of Part A needed over the next week, or any other attribute. A correction plan status attribute may show, for example, whether a critical issue was opened, was in progress, or was closed for Part A on the record date, or whether no critical issue was associated with Part A on the record date. The same record or a different record may chronicle similar attributes for Part B and other parts used in the manufacturing process. These identified records may be retrieved from data storage or otherwise made available for model development.

At 120, a first process component is selected. In example method 100, individual process components are assumed to be independent and are therefore considered separately. For example, in a manufacturing process involving Part A and Part B, it is assumed that the availability of Part A has no effect on the availability of Part B. Alternatively, in some embodiments, multiple process components may be processed simultaneously to account for dependencies among the multiple process components.

At 125, predictor variables are identified for the selected component. Predictor variables are used in model development and are based on one or more of the component's attributes as chronicled in the data records. Predictor variables can be evaluated for any record date using the attribute data from that record date and/or from the attribute data from earlier and later record dates. The following are examples of predictor variables for parts used in a manufacturing process:
Cumulative Days of Supply for the next N Weeks: takes into account the current supply of Part A, the quantity of Part A arriving in the next N weeks, and the quantity of Part A needed over the next N weeks.
N-Week Negative DNS Count: indicates the number of weeks when demand for Part A exceeds supply for Part A over an N-week period.
Demand Count: indicates the number of weeks where demand for Part A is greater than zero over a fixed time period.
Days of Supply: indicates the number of days that the supply of Part A can cover the demand for Part A.
Issue Count: indicates the number of critical issues involving Part A that have occurred over a fixed time period.
Hubbed: indicates whether a quantity of Part A is available from a regional supply facility.

The above list provides a few examples of predictor variables for parts used in a manufacturing process. This list is not an exclusive or exhaustive list of the number and type of predictor variables that may be identified for all components in all processes. Developing a predictive analytics model for an individual component or for multiple components of a particular process may involve experimenting with a variety of predictor variables to determine which are best suited for predicting a particular failure event. In some embodiments, predictor variable candidates may be assessed and prioritized into a pareto order so that the most effective predictors are identified early.

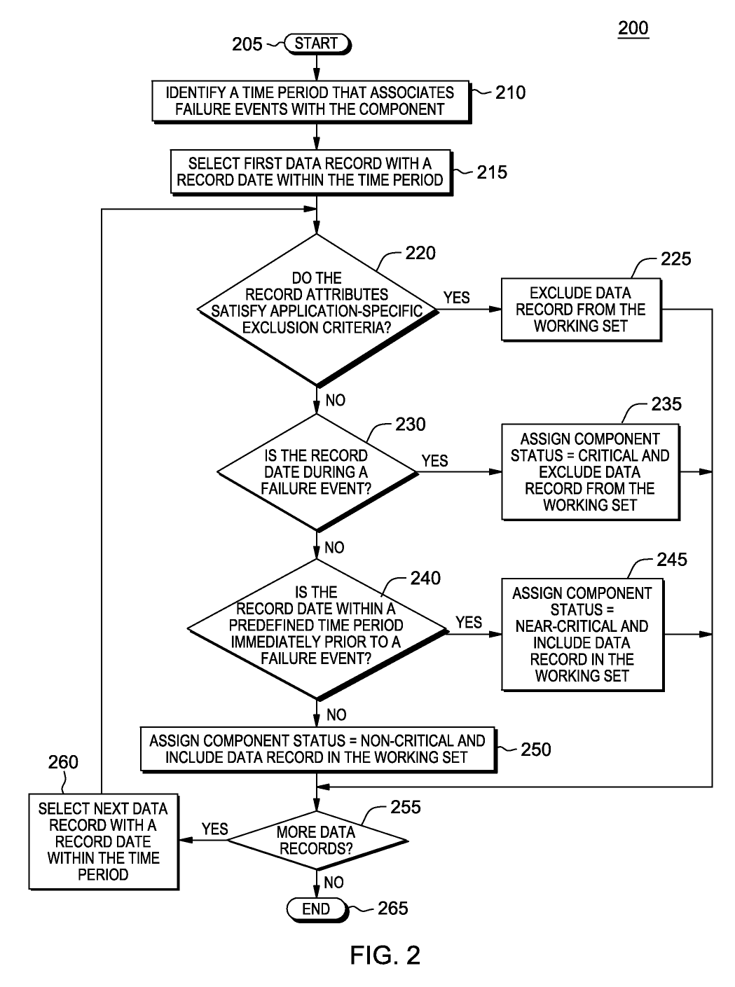

At 130, a working set of process data records is created from the historical set. The working set may include all records from the historical set, or may include less than all records from the historical set. Some records in the historical set may be excluded to ensure good quality data for use in developing the predictive analytics model. A status is also assigned to the component for each record date in the working set based on the known outcomes in the historical data. A phase in developing the predictive analytics model will be to predict the assigned component status with an acceptable level of accuracy and confidence. For example, if a correction plan status attribute for a component on a particular record date shows an association with a critical issue, then the component may be assigned a status of “critical” for that record date. Depending on the data, the component's status may remain critical over a range of record dates, for example until the correction plan status changes to “critical issue closed”. Working backward from the critical time period, the component may be assigned a status of “near-critical” for a predefined time period immediately preceding the critical time period. The component may then be assigned a status of “non-critical” for all record dates outside of critical and near-critical time periods. An example creation of a working set is described in more detail in FIG. 2.

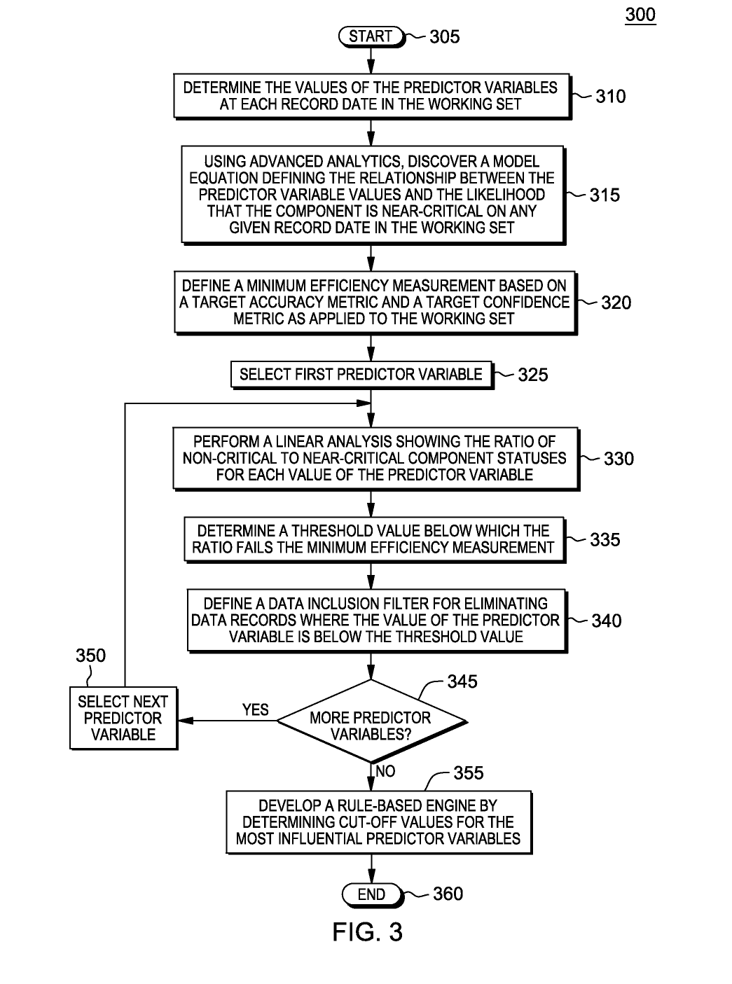

A predictive analytics model that predicts the assigned component status based on patterns in the predictor variable values is developed from the working set data at 135. Rather than using fixed algorithms and fixed analytics techniques, model equations may be discovered using a variety of analytics techniques, such as logistic regression or other generalized linear models, linear analysis, decision trees, rule-based engines, and artificial neural networks. An example development of a predictive analytics model is described in more detail in FIG. 3; however, any suitable technique for developing a predictive analytics model is contemplated.

If there are process components (which were identified at 110) for which a model has not yet been developed at 140, the next component is selected at 145. Predictor variables are identified, a working set is created, and the computer-based predictive analytics model is expanded to predict outcomes for the next component. Accordingly, an overall process model may be a conglomerate of different models developed for individual process components, rather than providing a “one size fits all” model for all components. For some processes, a model may be developed for only one process component. For other processes, multiple models may be developed for multiple process components. When multiple models are developed for multiple process components, the combined models may be referred to as a single model for the process with multiple component-dependent algorithms.

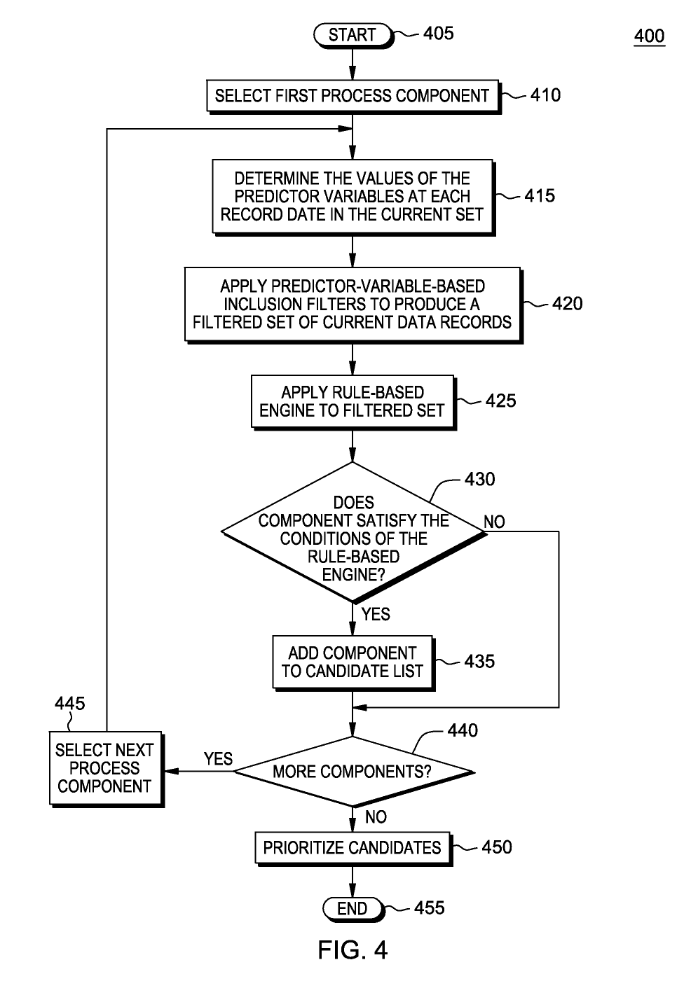

If there are no process components (which were identified at 110) remaining at 140, then if it is time to run the model at 150, a set of current process data records is identified at 155. Similarly or identically to the historical set, the current set chronicles the attributes of the components over time. The predictive analytics model is then applied to the current set of data records at 160. The predictive model may be run continuously as data is collected for the process, may be run according to a predetermined time schedule, may be run according to some other criteria, or may be run on an ad hoc basis. An example application of the predictive analytics model is described in more detail in FIG. 4.

If a failure event is predicted for any modeled process component at 165, then an action may be performed to avoid, mitigate, or otherwise address the predicted failure event at 170. For example, if a shortage is predicted for Part B in a manufacturing process, the action performed may be placing a new order for Part B, may be adjusting an existing order for Part B, may be providing a notification of the predicted shortage of Part B, may be adjusting an output forecast for a Part B-based product, or may be any other suitable action.

After performing an action at 170, then if it is time to refine the model at 175, the historical data set is refreshed at 180. Refreshing the historical data set may include adding recently created data records; may include adding data records from different but similar processes; may include removing data records due to age, reliability, or other criteria; or may include some other suitable modification of the historical set. The predictive model development process may then be repeated with the refreshed historical data set. Consequently, the predictive analytics models may be continuously updated and refined over time.

It should be noted that although example method 100 depicts a linear process of model development, model application, and model refinement, model application and refinement may occur in parallel. For example, once developed, a predictive analytics model may be run continuously or according to a schedule until a refined model is available. Model refinement may be performed continuously as data is collected for the process, may be performed according to a predetermined time schedule, may be performed according to some other criteria, or may be performed on an ad hoc basis.

FIG. 2 is a flow diagram of an example method 200 for creating a working set of historical process data records for use in developing a computer-based predictive analytics model for a process component. From start 205, a time period within the historical data set is identified in which failure events have occurred for the component. Selection of the time period may be influenced by any number of factors, but generally a larger data set is preferable to a smaller data set.

A first record in the historical set with a record date within the time period is selected at 215. If the values of the component attributes in the record satisfy application-specific exclusion criteria at 220, then that record may be excluded from the working set at 225. Exclusion criteria may be based on a record's usefulness in developing the predictive model. For example, in a manufacturing process involving Part A, a record for which the demand forecast for Part A is zero for a predetermined period of time may be excluded, since attribute data recorded on a date for which a component is not in demand may be useless in developing a predictive analytics model for that component, or worse, such data may adversely affect model development.

If the values of the component attributes in the record indicate that the component was associated with a failure event on the record date at 230, then the component may be assigned a status of “critical” for that record date and the record may be excluded from the working set at 235. For example, a record with a correction plan status attribute value of “critical issue proposed”, “critical issue open”, or “critical issue closed” for the component may be assigned a status of “critical” and excluded. Excluding attribute data collected while a component is already critically failing is consistent with developing an analytics model that can predict failures before they occur. Attribute data recorded during failure events, and especially toward closure of the failing events, may be affected by emergency corrective action and therefore the component's posture may be artificially improving. Such data may adversely affect model development.

If, at 240, the values of the component attributes in the record indicate that the component was not associated with a failure event on the record date, but the record date is within a predefined time period immediately preceding a failure event, then the component may be assigned a status of “near-critical” for the record date and the record may be included in the working set at 245. If the record date is beyond the predefined time period at 240, the component may be assigned a status of “non-critical” and the record may also be included in the working set at 250. For example, a record with a record date 13 weeks prior to a failure event may be assigned a status of “near-critical”, while a record with a record date 14 weeks prior to a failure event may be assigned a status of “non-critical”, and both are included in the working set. Attribute data recorded during near-critical and non-critical time periods may be the most appropriate for developing a predictive analytics model.

If more records remain to be evaluated for inclusion in the working set at 255, the next data record with a record date within the time period is selected at 260 and the data record is evaluated as above. When no more records remain at 255, the process ends at 265 and the working set is complete.

FIG. 3 is a flow diagram of an example method 300 for developing a computer-based predictive analytics model for a process component. From start 305, the predictor variables are evaluated for each record date in the working set at 310. As stated previously, predictor variables are based on one or more of the component's attributes as chronicled in the data records. At 315, advanced analytics is used to discover a model equation that defines the relationship between one or more of the predictor variables and the likelihood that the component will experience a future failure event.

In some embodiments, logistic regression may be used to find patterns among the predictor variable values in the working set data and to use these patterns to predict the component's assigned status on any given record date. For example, if the value of the component's assigned status at each record date in the working set is defined as 1 for “near-critical” and is defined as 0 for “non-critical”, then logistic regression may be used to determine the probability (Pi) that a component's assigned status (Yi) is equal to 0 (“non-critical”) on any given record date. The model equation used for this example may be Pi=Prob (Yi=0)=Exp (Li)/(1+Exp (Li)); where Li=a+(b1*1i)+(b2*2i)+ . . . +(bp*pi); where Yi and Yj are assumed independent for all I≠j; where a, b1, b2, . . . , and bp are the intercept and regression coefficients to be estimated; where 1i, 2i, . . . , and pi are predictor variables; and where the method of estimation is Maximum Likelihood. The results of such a logistic regression for the component may be, for example, a model equation where L=0.773+(0.00001*TwelveWeekMinCumDelta)+(0.166*TwelveWeekNegativeDNSCount)+(−0.673*CDOS7Week)+(−0.012*Leadtime), where TwelveWeekMinCumDelta, TwelveWeekNegativeDNSCount, CDOS7Week, and Leadtime are all predictor variables for the component.

Because it is unlikely that any model equation developed could predict the assigned status correctly for all record dates, performance metrics are used to measure the quality of the model equation's predictions. Performance metrics enable the comparison of competing model equations to determine which model equations perform better than others. Examples of performance metrics are accuracy metrics and confidence metrics. For a model equation that predicts whether a component status is “near-critical” or “non-critical” as described above, an accuracy metric may be defined as the number of record dates in the working set on which the component's status was correctly predicted as “near-critical” divided by the total number of record dates in the working set on which the component's status was assigned “near-critical”. Such an accuracy metric may therefore measure the proportion of actual “near-critical” statuses that can be detected by the model equation. A confidence metric may be defined as the number of record dates in the working set on which the component's status was correctly predicted as “near-critical” divided by the total number of record dates in the working set on which the component's status was predicted (correctly and incorrectly) as “near-critical”. An incorrect prediction of “near-critical” is considered a false positive. Such a confidence metric may therefore measure the proportion of predictions that are correct.

After the model equation is discovered at 315, a minimum efficiency measurement of the working set used to develop the model equation may be defined at 320. The minimum efficiency measurement accounts for the desired targets for accuracy and confidence for the model equation. The minimum efficiency measurement may be useful in determining inclusion criteria when running the predictive analytics model against a current data set.

For a model equation that predicts whether a component's status on a record date in the working set is “near-critical” (positive) or “non-critical” (negative) as described above, a minimum efficiency measurement may be defined as, for a desired accuracy and confidence, the number of “non-critical” statuses that would be accurately predicted (true negatives) divided by the number of “non-critical” statuses that would be inaccurately predicted as “near-critical” (false positives). For example, if the working set contains 83,000 records for which the component's assigned status is “non-critical” and 2150 records for which the component's assigned status is “near-critical”, then to meet a target accuracy of 60%, the model equation must accurately predict at least 1290 “near-critical” statuses (true positives). To further meet a target confidence of 60%, the model equation must inaccurately predict no more than 860 “near-critical” statuses (false positives). The minimum efficiency is then defined as (83000−860)/860=95.5. Consequently, when running the model against a current data set, a filter may be applied to the current data set that removes 95 records where the component status is “near-critical” for every record where the component status is “non-critical”.

Filters may be developed by performing linear analyses on the working set data. A first predictor variable is selected at 325. A linear analysis may then be performed at 330 that shows the individual efficiencies (the ratios of non-critical statuses to near-critical statuses) of the working set for each value of the predictor variable. For example, Table 1 below shows results of a linear analysis for a “Demand Count” predictor variable:

TABLE 1

| Demand Count | Component status = | Component status = | |
|---|---|---|---|
| value | non-critical | near-critical | Efficiency |
| 0 | 13003 | 4 | 3250.75 |
| 1 | 10399 | 50 | 207.98 |
| 2 | 5037 | 39 | 129.15 |
| 3 | 4240 | 65 | 65.23 |
| 4 | 3589 | 54 | 66.46 |
| 5 | 3122 | 81 | 38.54 |
| 6 | 3264 | 78 | 41.85 |
| 7 | 3299 | 88 | 37.49 |
| 8 | 3857 | 105 | 36.73 |
| 9 | 4939 | 174 | 28.39 |
| 10 | 6564 | 193 | 34.01 |
| 11 | 5855 | 215 | 27.23 |
| 12 | 7060 | 365 | 19.34 |
| 13 | 7553 | 665 | 11.36 |

In the Table 1 example, there are 13003 record dates in the working set where the Demand Count is zero and the component status is non-critical, and there are 4 record dates in the working set where the Demand Count is zero and the component status is near-critical. Consequently, the efficiency of the working set is 13003/4=3250.75 when the Demand Count is zero. Similarly, the efficiency of the working set is 10399/50=207.98 when the Demand Count=1, the efficiency is 5037/39=129.15 when the Demand Count=2, and so on through an efficiency of 7553/665=11.36 when the Demand Count=13.

The results of the linear analysis for the predictor variable may then be analyzed to determine a threshold value for the predictor variable at 335 and to define a data inclusion filter at 340. A useful threshold value is one that separates the working set into two groups of data: on one side of the threshold, efficiencies are above the minimum efficiency measurement (defined at 320), and on the other side of the threshold, efficiencies are below the minimum efficiency measurement. In the Table 1 example, for a minimum efficiency measurement of 95.5, a threshold value=3 for Demand Count. On record dates where Demand Count is less than 3, working set efficiencies are greater than 95.5. On record dates where Demand Count is greater than or equal to 3, working set efficiencies are less than 95.5. Consequently, a data inclusion filter may be defined that removes all records in a current data set for which Demand Count<3.

If more predictor variables remain to be evaluated for usefulness in defining data inclusion filters at 345, the next data predictor variable is selected at 350 and a linear analysis is performed as above. For example, a linear analysis of a “Hubbed” predictor variable may result an efficiency of 38.68 when Hubbed=Y and an efficiency of 222.88 when Hubbed=N. Consequently, a data inclusion filter may be defined that removes all records for which Hubbed=Y. It should be noted that some predictor variables may produce useful data inclusion filters while other predictor variables may not. In some embodiments, only some of the predictor variables may be evaluated.

When predictor variable evaluation is complete at 345, then a decision tree or rule-based engine may be developed at 355 for predicting failures. The most influential predictor variables in the relationship determined by the advanced analytics may be selected as the basis for a set of conditions. For example, a CART tree model may be used with a Gini impurity measure method, or a CHAID tree model may be used with a Chi Square Pearson impurity measure method. The method ends at 360.

It should be noted that example method 300 as depicted in FIG. 3 is only one of many possible example methods for developing a computer-based predictive analytics model for a process component, and that other methods are contemplated, including variations on method 300. For example, in some embodiments, the processes of blocks 330, 335, 340, and 355 are encompassed within the process of block 315. And although some advanced analytics methods such as classification trees are built by processing one predictor variable at a time, other advanced analytics methods such as neural networks consider all predictor variables concurrently.

FIG. 4 is a flow diagram of an example method for applying a computer-based predictive analytics model for predicting process failures to current process data records. From start 405, a first process component is selected at 410. At 415, the predictor variables are evaluated for each record date in the current set. As stated previously, predictor variables are based on one or more of the component's attributes as chronicled in the data records.

The current data set may then be filtered at 420 by evaluating whether the predictor variables satisfy the inclusion criteria identified during model development. The filtered set of data records are then supplied to the rule-based engine at 425. If the component's predictor variables satisfy the conditions of the rule-based engine at 430, then the component is added to the candidate list of components for which a failure event is predicted at 435. If more components remain to be processed at 440, the next component is selected at 445, and the process is repeated. Although example method 400 depicts a complete evaluation for each component before proceeding to the next component, in some embodiments, all or part of the predictor variable evaluations, the filtering, and the application of the rule-based engine may overlap or be performed in parallel for multiple components.

When all components have been processed at 440 and the candidate list of components for which a failure event is predicted is complete, the candidates may be prioritized at 450 and the method ends at 455. Prioritizing the predicted failing events may save time and effort in deciding what action or actions to take in anticipation of the failing events, and in what order to take multiple actions. For example, a predicted shortage for Part A may be considered a higher priority than a predicted shortage for Part B. A predicted shortage for a non-hubbed component may be considered a higher priority than a predicted shortage for a hubbed component. A predicted shortage for a component with a current supply less than 42 days may be considered a higher priority than a predicted shortage for a component with a current supply between 42 days and 64 days, which in turn may be considered a higher priority than a predicted shortage for a component with a current supply greater than 64 days. A predicted shortage for a component with a higher lead time increase may be considered a higher priority than a predicted shortage for a component with a lower lead time increase. This list of prioritization examples is not an exclusive or exhaustive list of the types of prioritizations contemplated.

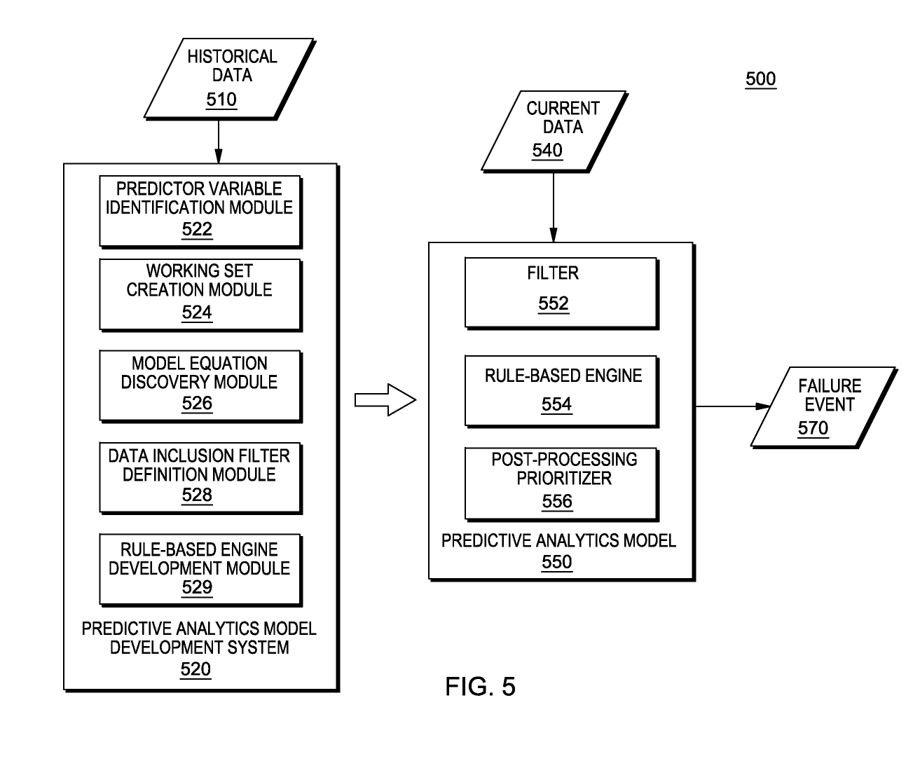

FIG. 5 is a block diagram of an example system 500 for predicting process failures using a computer-based predictive analytics model 550. A predictive analytics model development system 520 receives a set of historical data records 510 for a process. The historical data records chronicle various attributes of process components over time, including whether or not the components were associated with failure events, such as parts shortages. Each record has a record date and/or a record time, and each record provides a snapshot of the value of one or more of the components' attributes on the record date and/or the record time. Using the historical data 510, the predictive analytics model development system 520 produces a predictive analytics model 550. The predictive analytics model 550 is then applied to a set of current data records 540 to predict future failure events 570. One or more actions may then be taken in anticipation of the predicted failure events 570.

Predictive analytics model development system 520 may include one or more of a number of software modules, such as a predictor variable identification module 522, a working set creation module 524, a model equation discovery module 526, a data inclusion filter definition module 528, a rule-based engine development module 529, and may also include other modules not shown. Furthermore, in some embodiments one or more of the modules shown may be combined together in a single module or may be separated into multiple modules.

Predictive analytics model 550 may include one or more of a number of software modules, such as a filter 552, a rule-based engine 554, a post-processing prioritizer 556, and may also include other modules not shown. Furthermore, in some embodiments one or more of the modules shown may be combined together in a single module or may be separated into multiple modules.

A predictor variable identification module 522 may identify the process components' predictor variables that are suitable for model development, for example by using a method as described above. A working set creation module 524 may create a working set from the historical data set 510 for use by the model equation discovery module 526, for example by using a method as described above. A model equation discovery module 526 may use advanced analytics to discover a model equation that defines a relationship between the identified predictor variables and outcomes chronicled in the working set, for example by using a method as described above. A data inclusion filter definition module 528 may define a filter 552 for filtering the current data 540, for example by using a method as described above. Filtered current data may then enter a rule-based engine 554 developed by a rule-based engine development module 529, for example by using a method as described above. Output from the rule-based engine 554 may be prioritized by a post-processing prioritizer 556, for example by using a method as described above, before failure events 570 are predicted.

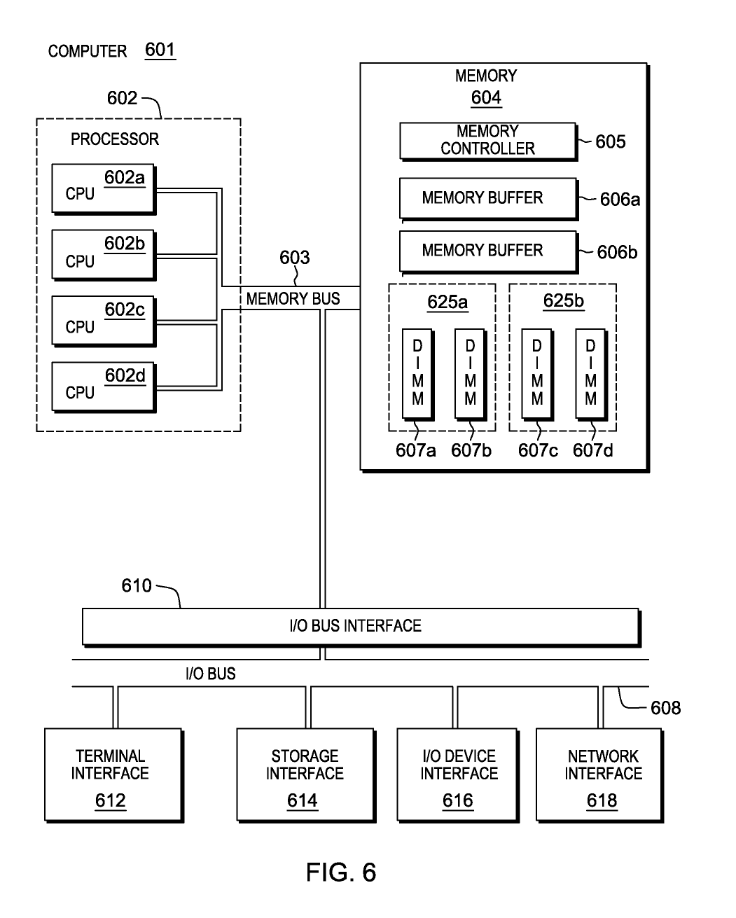

FIG. 6 depicts a high-level block diagram of an example system for implementing one or more embodiments of the invention. The mechanisms and apparatus of embodiments of the present invention apply equally to any appropriate computing system. The major components of the computer system 601 comprise one or more CPUs 602, a memory subsystem 604, a terminal interface 612, a storage interface 614, an I/O (Input/Output) device interface 616, and a network interface 618, all of which are communicatively coupled, directly or indirectly, for inter-component communication via a memory bus 603, an I/O bus 608, and an I/O bus interface unit 610.

The computer system 601 may contain one or more general-purpose programmable central processing units (CPUs) 602A, 602B, 602C, and 602D, herein generically referred to as the CPU 602. In an embodiment, the computer system 601 may contain multiple processors typical of a relatively large system; however, in another embodiment the computer system 601 may alternatively be a single CPU system. Each CPU 602 executes instructions stored in the memory subsystem 604 and may comprise one or more levels of on-board cache.

In an embodiment, the memory subsystem 604 may comprise a random-access semiconductor memory, storage device, or storage medium (either volatile or non-volatile) for storing data and programs. In another embodiment, the memory subsystem 604 may represent the entire virtual memory of the computer system 601, and may also include the virtual memory of other computer systems coupled to the computer system 601 or connected via a network. The memory subsystem 604 may be conceptually a single monolithic entity, but in other embodiments the memory subsystem 604 may be a more complex arrangement, such as a hierarchy of caches and other memory devices. For example, memory may exist in multiple levels of caches, and these caches may be further divided by function, so that one cache holds instructions while another holds non-instruction data, which is used by the processor or processors. Memory may be further distributed and associated with different CPUs or sets of CPUs, as is known in any of various so-called non-uniform memory access (NUMA) computer architectures.

The main memory or memory subsystem 604 may contain elements for control and flow of memory used by the CPU 602. This may include all or a portion of the following: a memory controller 605, one or more memory buffers 606 and one or more memory devices 607. In the illustrated embodiment, the memory devices 607 may be dual in-line memory modules (DIMMs), which are a series of dynamic random-access memory (DRAM) chips mounted on a printed circuit board and designed for use in personal computers, workstations, and servers. The use of DRAMs is exemplary only and the memory array used may vary in type as previously mentioned. In various embodiments, these elements may be connected with buses for communication of data and instructions. In other embodiments, these elements may be combined into single chips that perform multiple duties or integrated into various types of memory modules. The illustrated elements are shown as being contained within the memory subsystem 604 in the computer system 601. In other embodiments the components may be arranged differently and have a variety of configurations. For example, the memory controller 605 may be on the CPU 602 side of the memory bus 603. In other embodiments, some or all of them may be on different computer systems and may be accessed remotely, e.g., via a network.

Although the memory bus 603 is shown in FIG. 6 as a single bus structure providing a direct communication path among the CPUs 602, the memory subsystem 604, and the I/O bus interface 610, the memory bus 603 may in fact comprise multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 610 and the I/O bus 608 are shown as single respective units, the computer system 601 may, in fact, contain multiple I/O bus interface units 610, multiple I/O buses 608, or both. While multiple I/O interface units are shown, which separate the I/O bus 608 from various communications paths running to the various I/O devices, in other embodiments some or all of the I/O devices are connected directly to one or more system I/O buses.

In various embodiments, the computer system 601 is a multi-user mainframe computer system, a single-user system, or a server computer or similar device that has little or no direct user interface, but receives requests from other computer systems (clients). In other embodiments, the computer system 601 is implemented as a desktop computer, portable computer, laptop or notebook computer, tablet computer, pocket computer, telephone, smart phone, network switches or routers, or any other appropriate type of electronic device.

FIG. 6 is intended to depict the representative major components of an exemplary computer system 601. But individual components may have greater complexity than represented in FIG. 6, components other than or in addition to those shown in FIG. 6 may be present, and the number, type, and configuration of such components may vary. Several particular examples of such complexities or additional variations are disclosed herein. The particular examples disclosed are for example only and are not necessarily the only such variations.

The memory buffer 606, in this embodiment, may be an intelligent memory buffer, each of which includes an exemplary type of logic module. Such logic modules may include hardware, firmware, or both for a variety of operations and tasks, examples of which include: data buffering, data splitting, and data routing. The logic module for memory buffer 606 may control the DIMMs 607, the data flow between the DIMM 607 and memory buffer 606, and data flow with outside elements, such as the memory controller 605. Outside elements, such as the memory controller 605 may have their own logic modules that the logic module of memory buffer 606 interacts with. The logic modules may be used for failure detection and correcting techniques for failures that may occur in the DIMMs 607. Examples of such techniques include: Error Correcting Code (ECC), Built-In-Self-Test (BIST), extended exercisers, and scrub functions. The firmware or hardware may add additional sections of data for failure determination as the data is passed through the system. Logic modules throughout the system, including but not limited to the memory buffer 606, memory controller 605, CPU 602, and even DRAM may use these techniques in the same or different forms. These logic modules may communicate failures and changes to memory usage to a hypervisor or operating system. The hypervisor or the operating system may be a system that is used to map memory in the system 601 and tracks the location of data in memory systems used by the CPU 602. In embodiments that combine or rearrange elements, aspects of the firmware, hardware, or logic modules capabilities may be combined or redistributed. These variations would be apparent to one skilled in the art.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

What is claimed is:

1. A method for predicting failures in a process, the method comprising:
identifying a set of data records generated over a time period, each data record having a record date within the time period, the set of data records chronicling attributes of a component in the process during the time period, the component associated with at least one failure event during the time period;
assigning a status to the component on each record date in the set based on a temporal proximity of the record date to the at least one failure event;
developing a computer-based predictive analytics model based at least in part on a model equation for predicting the status on a plurality of the record dates in the set, each predicted status based at least in part on the attributes chronicled on the associated record date;
identifying a second set of data records generated over a second time period, the second set of data records chronicling the attributes during the second time period;
predicting a future failure event by applying the computer-based predictive analytics model to the second set of data records; and
performing an action based on the predicting the future failure event.

2. The method of claim 1, wherein the future failure event is a future shortage event for the component, and wherein the action is selected from the group consisting of:
placing a new order for the component;
adjusting an existing order for the component;
providing a notification of the predicted future shortage event; and
adjusting an output forecast.

3. The method of claim 2, wherein the attributes of the component include at least one of a quantity of the component in local stock, a quantity of the component in regional stock, a supply forecast for the component, a demand forecast for the component, and a correction plan status for the component.

4. The method of claim 1, wherein the developing and the applying the computer-based predictive analytics model use a plurality of analytics techniques selected from the group consisting of a linear analysis, a logistic regression, a generalized linear model, a decision tree, a rule-based engine, and an artificial neural network.

5. The method of claim 1, wherein the set of data records further chronicles second attributes of a second component in the process during the time period, wherein the second set of data records further chronicles the second attributes during the second time period, wherein the second component is associated with at least one second failure event during the time period, wherein the computer-based predictive analytics model is further based at least in part on a second model equation for predicting a second status on a second plurality of the record dates in the set, wherein each predicted second status is based at least in part on the second attributes chronicled on the associated record date, and wherein the second model equation is different from the model equation, the method further comprising:
assigning the second status to the second component on each record date in the set based on the temporal proximity of the record date to the at least one second failure event.

6. The method of claim 1, wherein the assigned status of the component on each record date is selected from the group consisting of critical, near-critical, and non-critical, and wherein the developing the computer-based predictive analytics model comprises:
forming a working set of data records by eliminating the data records for which the assigned status of the component is critical on the record date of the data record;
identifying a set of predictor variables based on the attributes of the component, each record in the working set having a value for each predictor variable;
using logistic regression to determine the model equation that defines a relationship between the values of the predictor variables and the status of the component on each record date in the working set; and
developing a rule-based engine based on the relationship, wherein conditions associated with the rule-based engine set limits for the values of a subset of the predictor variables.

7. The method of claim 6, wherein the computer-based predictive analytics model is associated with at least one target performance metric, and wherein the applying the computer-based predictive analytics model comprises:
developing at least one filter based on the at least one target performance metric and further based on the working set of data records;
applying the at least one filter to the second set of data records to produce a third set of data records; and
applying the rule-based engine to the third set of data records.

8. The method of claim 1, further comprising:
refreshing the set of data records with a plurality of new data records; and
refining the computer-based predictive analytics model using the refreshed set.

9. A computer program product for predicting failures in a process, the computer program product comprising a computer readable storage medium having program instructions embodied therewith, the program instructions executable by a processor to perform a method comprising:
identifying a set of data records generated over a time period, each data record having a record date within the time period, the set of data records chronicling attributes of a component in the process during the time period, the component associated with at least one failure event during the time period;
assigning a status to the component on each record date in the set based on a temporal proximity of the record date to the at least one failure event;
developing a computer-based predictive analytics model based at least in part on a model equation for predicting the status on a plurality of the record dates in the set, each predicted status based at least in part on the attributes chronicled on the associated record date;
identifying a second set of data records generated over a second time period, the second set of data records chronicling the attributes during the second time period;
predicting a future failure event by applying the computer-based predictive analytics model to the second set of data records; and
performing an action based on the predicting the future failure event.

10. The computer program product of claim 9, wherein the future failure event is a future shortage event for the component, and wherein the action is selected from the group consisting of:
placing a new order for the component;
adjusting an existing order for the component;
providing a notification of the predicted future shortage event; and
adjusting an output forecast.

11. The computer program product of claim 10, wherein the attributes of the component include at least one of a quantity of the component in local stock, a quantity of the component in regional stock, a supply forecast for the component, a demand forecast for the component, and a correction plan status for the component.

12. The computer program product of claim 9, wherein the developing and the applying the computer-based predictive analytics model use a plurality of analytics techniques selected from the group consisting of a linear analysis, a logistic regression, a generalized linear model, a decision tree, a rule-based engine, and an artificial neural network.

13. The computer program product of claim 9, wherein the set of data records further chronicles second attributes of a second component in the process during the time period, wherein the second set of data records further chronicles the second attributes during the second time period, wherein the second component is associated with at least one second failure event during the time period, wherein the computer-based predictive analytics model is further based at least in part on a second model equation for predicting a second status on a second plurality of the record dates in the set, wherein each predicted second status is based at least in part on the second attributes chronicled on the associated record date, and wherein the second model equation is different from the model equation, and wherein the method further comprises:
assigning the second status to the second component on each record date in the set based on the temporal proximity of the record date to the at least one second failure event.

14. The computer program product of claim 9, wherein the assigned status of the component on each record date is selected from the group consisting of critical, near-critical, and non-critical, and wherein the developing the computer-based predictive analytics model comprises:
forming a working set of data records by eliminating the data records for which the assigned status of the component is critical on the record date of the data record;
identifying a set of predictor variables based on the attributes of the component, each record in the working set having a value for each predictor variable;
using logistic regression to determine the model equation that defines a relationship between the values of the predictor variables and the status of the component on each record date in the working set; and
developing a rule-based engine based on the relationship, wherein conditions associated with the rule-based engine set limits for the values of a subset of the predictor variables.

15. The computer program product of claim 14, wherein the computer-based predictive analytics model is associated with at least one target performance metric, and wherein the applying the computer-based predictive analytics model comprises:
developing at least one filter based on the at least one target performance metric and further based on the working set of data records;
applying the at least one filter to the second set of data records to produce a third set of data records; and
applying the rule-based engine to the third set of data records.

16. The computer program product of claim 9, wherein the method further comprises:
refreshing the set of data records with a plurality of new data records; and
refining the computer-based predictive analytics model using the refreshed set.

17. A computer system for predicting failures in a process, the computer system comprising:
a memory; and
a processor in communication with the memory, wherein the computer system is configured to perform a method, the method comprising:
identifying a set of data records generated over a time period, each data record having a record date within the time period, the set of data records chronicling attributes of a component in the process during the time period, the component associated with at least one failure event during the time period;
assigning a status to the component on each record date in the set based on a temporal proximity of the record date to the at least one failure event;
developing a computer-based predictive analytics model based at least in part on a model equation for predicting the status on a plurality of the record dates in the set, each predicted status based at least in part on the attributes chronicled on the associated record date;
identifying a second set of data records generated over a second time period, the second set of data records chronicling the attributes during the second time period;
predicting a future failure event by applying the computer-based predictive analytics model to the second set of data records; and
performing an action based on the predicting the future failure event.

18. The computer system of claim 17, wherein the future failure event is a future shortage event for the component, and wherein the action is selected from the group consisting of:
placing a new order for the component;
adjusting an existing order for the component;
providing a notification of the predicted future shortage event; and
adjusting an output forecast.

19. The computer system of claim 18, wherein the attributes of the component include at least one of a quantity of the component in local stock, a quantity of the component in regional stock, a supply forecast for the component, a demand forecast for the component, and a correction plan status for the component.

20. The computer system of claim 17, wherein the developing and the applying the computer-based predictive analytics model use a plurality of analytics techniques selected from the group consisting of a linear analysis, a logistic regression, a generalized linear model, a decision tree, a rule-based engine, and an artificial neural network.
